(19) United States
(12) Patent Application Publication
(10) Pub. No.: US 2005/0082111 A1
(43) Pub. Date: Apr. 21, 2005

(54) Acoustic baffle

(75) Inventor: Philip E. Weber, Novi, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Sika Technology AG, Baar (CH)

(21) Appl. No.: 10/688,352

(22) Filed: Oct. 18, 2003

(51) Int. Cl. F01N 1/00; G10K 11/00

(52) U.S. Cl. 181/204; 181/205

(57) ABSTRACT

A baffle for use in a cavity of a structural member is disclosed. In an embodiment of the invention, the baffle includes a support member having a first wall and a second wall. The first wall is spaced apart from the second wall so as to define an acoustical gap of predetermined dimension therebetween. A sealing material is operably coupled with and supported by at least a portion of the support member.

### BACKGROUND OF THE INVENTION

1. Field of the Invention

The present invention concerns the use of sealing materials, particularly thermally expandable structural reinforcing materials that are supported by an acoustical member to provide localized stiffness and sound suppression to frames, rails, cavities, panels and other structural members.

2. Description of the Related Art

Structural members, such as automotive vehicle bodies, typically have a variety of hollow posts, cavities, passages and similar areas that can transmit undesirable noises, air currents, moisture, dust and other airborne particulates unless sealed to prevent infiltration of such sounds or contaminants. In automotive applications, for example, a thermally expandable sealing material is typically provided in a vehicle body, which may be formed into a desired shape so that upon insertion into a post, cavity or passage of the vehicle body, the component will undergo heat-induced expansion when the vehicle body is conveyed through a baking oven forming a part of the primer or paint curing step of the automobile manufacturing process.

Recently, baffles have been developed that include a sealing material disposed on a support member or carrier. The carrier is generally manufactured from a rigid material, such as hard plastic, such that its shape approximates the shape of the cavity to be sealed. The carrier/sealing material combination is configured such that the carrier is inserted into a cavity, and the sealing material creates an airtight seal between the carrier and the walls of the cavity. Typically, the sealing material is activated (thermally or chemically) shortly before or after insertion into the cavity so that the sealing material forms a seal with the walls of the cavity. While baffles have been successfully employed to seal automotive body cavities against the intrusion of dust, water, carbon monoxide and to a certain extent noise, a need exists for an improved baffle with enhanced sound suppression capability.

### SUMMARY OF THE INVENTION

A baffle for use in a cavity of a structural member is disclosed. In an embodiment of the invention, the baffle includes a support member having a first wall and a second wall. The first wall is spaced apart from the second wall so as to define an acoustical gap of predetermined dimension therebetween. A sealing material is operably coupled with and supported by at least a portion of the support member.

### BRIEF DESCRIPTION OF THE DRAWINGS

Embodiments of the invention will now be described, by way of example, with reference to the accompanying drawings, wherein:

FIG. 1 is a perspective view of an automobile body, illustrating various pillars and rails within which the baffle of the present invention may be utilized;

FIG. 2 is a side elevation view of a baffle according to an embodiment of the present invention, shown installed in an automotive body cavity;

FIG. 3 is a cross-sectional view of the baffle of FIG. 2 taken along line 3-3;

FIG. 4 is a perspective view of the baffle of FIG. 2, showing a wall of the baffle partially removed to illustrate an acoustical gap;

FIG. 5 is a perspective view of a reference baffle, similar to the baffle of FIG. 4, except with no acoustical gap; and

FIG. 6 is a graph of sound transmission loss versus noise frequency for a baffle according to a particular implementation of the present invention and a similarly dimensioned baffle without an acoustical gap.

### DETAILED DESCRIPTION OF THE INVENTION

Referring now to the drawings, an exemplary automobile body 10 is shown in FIG. 1. Automobile body 10 represents a particular use of the present invention; however, other examples of use include, without limitation, aircraft, domestic appliances, buildings, walls and partitions, and marine applications. When used in automotive applications, the present invention may be used in structural members 12 and 14. For example, a baffle 16 is shown installed in automobile body 10 within pillars 14 in FIG. 1.

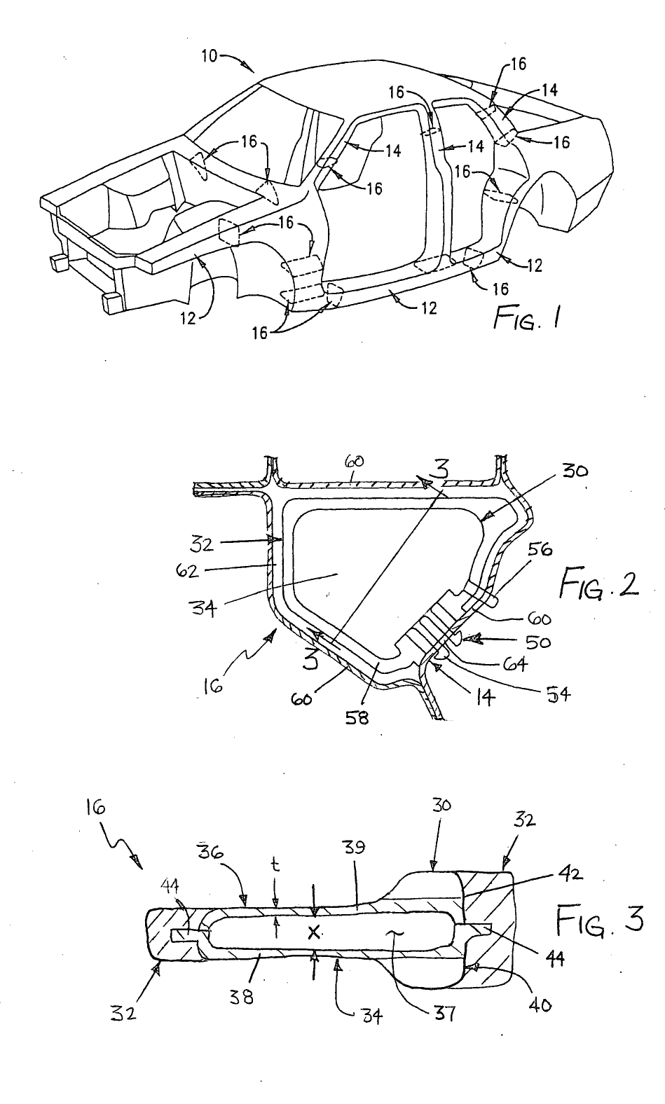

Referring now to FIGS. 2 and 3, an embodiment of baffle 16 is shown in accordance with the present invention. In the illustrated embodiment, baffle 16 includes a support member 30 and a sealing material 32 positioned around at least a portion of a perimeter of support member 30. In a particular configuration, support member 30 includes a first support half 34 and a second support half 36 (FIG. 3). A portion of first support half 34 is spaced apart from second support half 36 so as to define an acoustical gap 37 of predetermined dimension therebetween. As shown in FIGS. 2 and 3, acoustical gap 37 may be an enclosed area defined by a first wall 38 and a second wall 39. However, in other configurations, acoustical gap 37 may be only partially enclosed. A fluid, such as air, may be contained within acoustical gap 37, or gap 37 may be void of any medium.

In an embodiment, support member 30 is made of a moldable material that is pliable and, therefore, resistant to cracks and breakage. An exemplary material is a heat stabilized, glass-reinforced nylon, such as NYLIND 51 HSL BK00 1 by DuPont. However, other materials may be used depending on the desired physical characteristics of the particular application. When support member is made from a moldable material, first and second support halves 34, 36 may be manufactured separately and later joined, such as by sonic welding, to create acoustical gap 37. In another embodiment, first and second halves 34, 36 may be formed as a one piece, clam-shell structure and then folded unto itself to created acoustical gap 37. In yet another embodiment, first and second support halves 34, 36 may be integrally formed, such as in a blow-molding operation, with acoustic gap 37 being defined within the unitary support member 30.

In the embodiment illustrated in FIG. 3, support member 30 includes a peripheral rim 40. In an embodiment, rim 40 includes a base wall 42, which inhibits any inward expansion or migration of sealing material 32 after activation and is oriented at an oblique angle relative to walls 38, 39. Rim 40 may optionally include a support flange 44 that extends outwardly (transversely to the axial direction of the structural member 14) from base wall 42. When so configured, flange 44 functions as an anchor to assist in coupling sealing material 32 to support member 30.

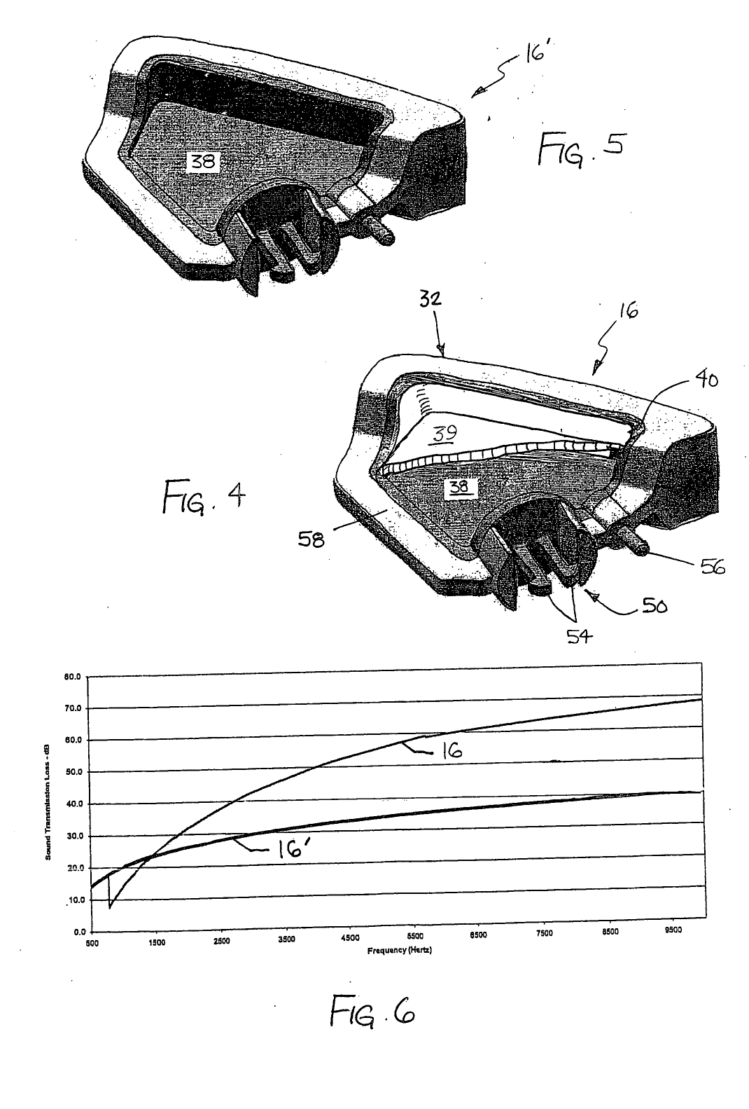

As shown in FIGS. 2 and 4, support member 30 may also include an attachment member 50 for coupling baffle 16 to structural member 14. In an embodiment, attachment member 50 is integrally molded with a portion of rim 40 and includes a pair of resiliently deflectable barbs 54 configured for secured receipt in an opening in structural member 14. Support member 30 may also include a positioning member 56, such as a cylindrical post, that extends outward from rim 40 for receipt in an opening in structural member 14. Sealing material 32 is molded in place around rim 40 to provide a generally uninterrupted band 58. However, as shown in FIG. 4, sealing material 32 may be divergent around attachment member 50 and positioning member 56.

In a particular implementation of the invention, sealing material 32 is a thermally expandable, dry, initially non-tacky material that develops adhesion upon foaming and expansion so that it adheres to the surrounding structural member 14 when activated. When subjected to a temperature of at least about 300° F. (149° C.), sealing material 32 exhibits a percent expansion of at least about 40%, but generally less than about 300% to provide sufficient structural reinforcement and compression strength. The expanded sealing material 32 fills the cavity and bonds to the interior surface of structural member 14. FIG. 2 shows sealing material 32 in its initial, unactivated state with a gap present between the cavity wall and sealing material 32.

One preferred type of thermally expansible sealing material is sold by Sika Corporation of Madison Heights, Mich. under the designation Sikabaffle 240, and is described in U.S. Pat. Nos. 5,266,133 and 5,373,027 to Hanley et al., the disclosures of which are incorporated herein by reference. Alternatively, if greater reinforcing properties are desired with less expansion, sealing material 32 may be a reinforcing material such as that sold by Sika Corporation under the designation Sikareinforcer 941, as described in U.S. Pat. No. 6,387,470, the disclosure of which is incorporated herein by reference. Other suitable sealing materials capable of sealing and expansion may also be used.

Sealing material 32 may be activated by the external application of heat, or internally activated by an exothermic reaction. When used in an automobile body 10, for example, sealing material 32 typically exhibits an activation temperature lower than the temperature for baking paint on the body during manufacture. For example, it is conventional to employ a bake temperature of about 350° F. (177° C.). Accordingly, when used in this application, the thermally expansible sealing material 32 may exhibit an activation temperature of about 300° F. (149° C.) or less. In automotive applications, support member 30 generally exhibits a melting temperature above the temperature likely to be encountered in automotive bake ovens.

The size and shape of support member 30 illustrated in FIGS. 2-4 is such that sealing material 32 is maintained substantially in position prior to baking. Furthermore, the flow of sealing material 32 is sufficiently directed by support member 30 during expansion so that the expanded material contacts and adheres to the cavity walls of structural member 14. However, it will be appreciated that the size and shape of support member 30 is not limited to the embodiment shown in FIGS. 2-4.

With reference to FIGS. 3 and 4, a particular implementation of baffle 16 is shown, wherein the thickness “t” of each wall 38, 39 is approximately 1 mm (0.039 in) and the dimension “x” between each wall 38, 39 is approximately 5 mm (0.197 in). For reference only, a slightly modified version of baffle 16 is shown in FIG. 5, which is denoted by reference character 16′. Unlike baffle 16 shown in FIGS. 2-4, reference baffle 16′ does not include a second wall 39 spaced apart from first wall 38 and, therefore, does not include an acoustical gap 37.

With reference to FIG. 6, sound transmission loss, in decibels, is plotted against frequency of noise, in hertz, for both baffle 16 shown in FIGS. 2-4 and reference baffle 16′ shown in FIG. 5. Notably, at approximately 600 hertz, baffle 16 (FIGS. 2-4), which includes acoustical gap 37, exhibits enhanced sound suppression capability over the single walled baffle 16′ (FIG. 5) that does not include an acoustical gap 37. The improved sound suppression capability of baffle 16 at approximately 600 hertz is attributable to the resonance between first and second walls 38, 39 at that particular frequency and the dimension of acoustical gap 37 therebetween.

The improved sound suppression performance exhibited by baffle 16 is not limited to the particular implementation described above and shown in FIGS. 2-4. More particularly, the size, shape and other physical characteristics of support member 30, as well as the dimensions of acoustical gap 37, may be modified for a particular application to improve the sound suppression performance of baffle 16 at a particular frequency or range of frequencies. For example, by reducing the dimension “x” between walls 38, 39 below 5 mm (0.197 in) in the above-described implementation of baffle 16, the improved sound suppression capability of baffle 16 occurs at a frequency higher than approximately 600 hertz.

Although the acoustical gap 37 depicted in FIG. 3 appears to be of generally uniform width “x” through the cross-section of baffle 16, it is not necessarily limited thereto. Alternatively, width “x” may vary throughout the cross-section of baffle 16, provided some distance separates first wall 38 from second wall 39. In another embodiment of the invention, baffle 16 may even include more than one acoustical gap 37, each acoustical gap exhibiting a varying or substantially uniform width.

In an automotive application, baffle 16 may be provided to automobile manufacturers preassembled (i.e., with the non-expanded sealing material 32 insert molded to support member 30) for insertion into the cavity of the desired rail or pillar during construction of the automobile. Referring to FIG. 2, for example, one of the walls 60 forming a cavity 62 includes structure defining an opening 64 of sufficient size and shape to allow attachment member 50 to be secured therein. That is, attachment member 50 is inserted into opening 64 under slight force, causing barbs 54 to be reversibly biased towards toward each other. After the barbs 54 have passed through opening 64, barbs 54 return to essentially their unbiased position, preventing attachment member 50 from being removed from opening 64 and securing baffle 16 within cavity 62. Receipt of positioning member 56 into a corresponding opening in wall 60 inhibits movement of baffle 16 in cavity 62 prior to activation of sealing material 32. At this point in the assembly process, sealing material 32 may or may not be in contact with some or all of the cavity walls 60, depending upon the size and shape into which sealing material 32 is molded.

Once baffle 16 is positioned within cavity 62, it remains in place until such time as the automobile body 10 is exposed to an elevated temperature sufficient to activate sealing material 32 and cause it to expand and/or adhere against cavity walls 60. As will be appreciated, any number of processed or manufacturing steps may be carried out on the automobile body prior to baking without affecting the ability of sealing material 32 to expand when exposed to the activating temperature.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. A baffle for use in a cavity of a structural member, the baffle comprising:
a support member including a first wall and a second wall, the first wall spaced apart from the second wall so as to define an acoustical gap of predetermined dimension therebetween; and
a sealing material operably coupled with and supported by at least a portion of the support member.

2. The baffle of claim 1, wherein the acoustical gap is enclosed.

3. The baffle of claim 1, wherein the acoustical gap includes a fluid.

4. The baffle of claim 3, wherein the fluid is air.

5. The baffle of claim 1, wherein the support member includes an attachment member for securing the baffle to the structural member.

6. The baffle of claim 1, wherein the sealing material is configured to expand when heated to a predetermined temperature.

7. The baffle of claim 6, wherein the support member includes a material having a melting point higher than the expansion temperature of the sealing material.

8. The baffle of claim 1, wherein the sealing material is disposed about a perimeter of the support member.

9. A baffle for use in a cavity of a structural member, the baffle comprising:
a support member including a first support half and a second support half, at least a portion of the first support half spaced apart from the second support half so as to define an acoustical gap of predetermined dimension therebetween; and
a sealing material supported by at least one of the first and second support halves.

10. The baffle of claim 9, wherein the first support half is secured to the second support half.

11. The baffle of claim 9, wherein the support member includes a rim disposed around a perimeter of the support halves.

12. The baffle of claim 11, wherein the sealing material is operably coupled with and supported by the rim.

13. A noise attenuated structural member, comprising:
a structural member defying a cavity; and
a baffle positioned in the cavity, the baffle comprising a support member including a first wall and a second wall, the first wall spaced apart from the second wall so as to define an acoustical gap of predetermined dimension therebetween; and a sealing material positioned between the support member and the structural member.

14. The noise attenuated structural member of claim 13, wherein the acoustical gap is enclosed.

15. The noise attenuated structural member of claim 13, wherein the acoustical gap includes a fluid.

16. The noise attenuated structural member of claim 15, wherein the fluid is air.

17. The noise attenuated structural member of claim 13, wherein the support member includes an attachment member for securing the baffle to the structural member.

18. The noise attenuated structural member of claim 13, wherein the sealing material is configured to expand when heated to a predetermined temperature.

19. The noise attenuated structural member of claim 18, wherein the support member includes a material having a melting point higher than the expansion temperature of the sealing material.

20. The noise attenuated structural member of claim 13, wherein the sealing material is operably coupled with and supported by at least a portion of the support member.
